(19) United States
(12) Patent Application Publication
(10) Pub. No.: US 2023/0386181 A1
(43) Pub. Date: Nov. 30, 2023

(54) DATA CREATION SYSTEM, LEARNING SYSTEM, ESTIMATION SYSTEM, PROCESSING DEVICE, DATA CREATION METHOD, AND PROGRAM

(71) Applicant: Panasonic Intellectual Property Management Co., Ltd., Osaka (JP)

(72) Inventors: Taichi SATO, Kyoto (JP); Ryosuke GOTO, Osaka (JP); Yuto KITAGAWA, Osaka (JP)

(21) Appl. No.: 18/249,895

(22) PCT Filed: Nov. 5, 2021
(86) PCT No.: PCT/JP2021/040715

§ 371 Date: Apr. 20, 2023

(30) Foreign Application Priority Data
Nov. 10, 2020 (JP) 2020-187510

(51) Int. Cl. G06V 10/774; G06T 3/00; G06V 10/82

(52) U.S. Cl. CPC G06V 10/774; G06T 3/0012; G06V 10/82

(57) ABSTRACT

A data creation system creates, based on first image data, second image data for use as learning data to generate a learned model about an object. The data creation system includes a deformer that generates, based on the first image data including a pixel region representing the object, the second image data by deforming a shape of the object. The deformer generates the second image data to maintain a predetermined feature of the first image data before and after the shape of the object is deformed.

### TECHNICAL FIELD

The present disclosure generally relates to a data creation system, a learning system, an estimation system, a processing device, a data creation method, and a program. More particularly, the present disclosure relates to a data creation system for generating image data for use as learning data to generate a learned model about an object, a learning system for generating the learned model, and an estimation system that uses the learned model. The present disclosure also relates to a processing device for use in the data creation system. The present disclosure further relates to a data creation method and program for generating image data for use as learning data to generate a learned model about an object.

### BACKGROUND ART

Patent Literature 1 discloses an X-ray image object recognition system. In the X-ray image object recognition system, a learning network performs machine learning using a learning set including an X-ray image of an object and a label. Patent Literature 1 also teaches, when the amount of learning data is insufficient, performing, as processing of expanding the learning data, data augmentation for increasing a pseudo number of images by moving, rotating, scaling up or down, and/or flipping the original image.

Patent Literature 1 further teaches that performing such data augmentation by moving, rotating, scaling up or down, and/or flipping the original image would create an image representing an unreal scene and make unintended learning to cause a decline in the performance of recognizing the object in the inference phase. Thus, the X-ray image object recognition system avoids performing such unintended data augmentation by appropriately setting parameters (which include at least one of the X-ray image scaling factor, magnitude of shift, or rotational angle) for use in the data augmentation.

The X-ray image object recognition system of Patent Literature 1 just sets those parameters such as X-ray image scaling factor, magnitude of shift, and rotational angle. Thus, depending on the object, there are still chances of creating an unreal image. Consequently, this would cause a decline in object recognition performance in the inference phase.

### CITATION LIST

### Patent Literature

Patent Literature 1: JP 2020-14799 A

### SUMMARY OF INVENTION

In view of the foregoing background, it is therefore an object of the present disclosure to provide a data creation system, a learning system, an estimation system, a processing device, a data creation method, and a program, all of which are configured or designed to reduce the chance of causing a decline in object recognition performance.

A data creation system according to an aspect of the present disclosure creates, based on first image data, second image data for use as learning data to generate a learned model about an object. The data creation system includes a deformer that generates, based on the first image data including a pixel region representing the object, the second image data by deforming a shape of the object. The deformer generates the second image data to maintain a predetermined feature of the first image data before and after the shape of the object is deformed.

A learning system according to another aspect of the present disclosure generates the learned model using a learning data set. The learning data set includes the learning data as the second image data created by the data creation system described above.

An estimation system according to still another aspect of the present disclosure estimates a particular condition of the object as an object to be recognized using the learned model generated by the learning system described above.

A processing device according to yet another aspect of the present disclosure functions as the first processing device out of the first processing device and second processing device of the data creation system described above. The first processing device includes the acquirer that acquires information about the predetermined feature. The second processing device includes the deformer.

Another processing device according to yet another aspect of the present disclosure functions as the second processing device out of the first processing device and second processing device of the data creation system described above. The first processing device includes the acquirer that acquires information about the predetermined feature. The second processing device includes the deformer.

A learning system according to yet another aspect of the present disclosure generates, using a learning data set including first image data as learning data, a learned model about an object. The first image data includes a pixel region representing the object. The learning system outputs, in response to the second image data, an estimation result similar to a situation where the first image data is subjected to estimation made about a particular condition of the object. The second image data is generated based on the first image data by deforming the shape of the object to maintain a predetermined feature of the first image data.

An estimation system according to yet another aspect of the present disclosure estimates a particular condition of an object as an object to be recognized. The estimation system outputs, in response to the second image data, an estimation result similar to a situation where the first image data, including a pixel region representing the object, is subjected to estimation made about the particular condition of the object. The second image data is generated based on the first image data by deforming the shape of the object to maintain a predetermined feature of the first image data.

A data creation method according to yet another aspect of the present disclosure is a method for creating, based on first image data, second image data for use as learning data to generate a learned model about an object. The data creation method includes a deforming step including generating, based on the first image data including a pixel region representing the object, the second image data by deforming a shape of the object. The deforming step includes generating the second image data to maintain a predetermined feature of the first image data before and after the shape of the object is deformed.

A program according to yet another aspect of the present disclosure is designed to cause one or more processors to perform the data creation method described above.

### BRIEF DESCRIPTION OF DRAWINGS

FIG. 1 is a block diagram illustrating a schematic configuration for an overall evaluation system including a data creation system according to an exemplary embodiment;

FIGS. 2A and 2B are plan views of first image data input to the data creation system;

FIGS. 3A and 3B are schematic representations illustrating how a deformer of the data creation system performs deformation processing;

FIG. 4 is a plan view of second image data generated by the deformer of the data creation system;

FIG. 5 is a flowchart showing a procedure of operation of the data creation system;

FIG. 6 is a plan view of first image data input to a first variation of the data creation system;

FIGS. 7A-7C are schematic representations illustrating how a deformer performs deformation processing in the first variation;

FIG. 8A is a plan view of first image data input to a second variation of the data creation system;

FIG. 8B is a schematic representation of input data specified externally;

FIG. 8C is a plan view of second image data generated by a deformer according to the second variation; and

FIG. 9 is a block diagram illustrating a schematic configuration for a third variation of the data creation system.

### DESCRIPTION OF EMBODIMENTS

(1) Overview

The drawings to be referred to in the following description of embodiments are all schematic representations. Thus, the ratio of the dimensions (including thicknesses) of respective constituent elements illustrated on the drawings does not always reflect their actual dimensional ratio.

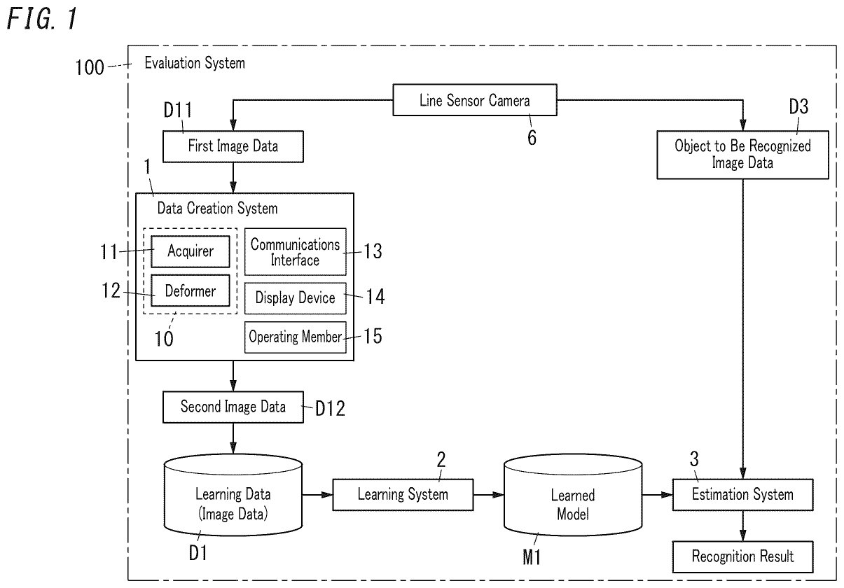

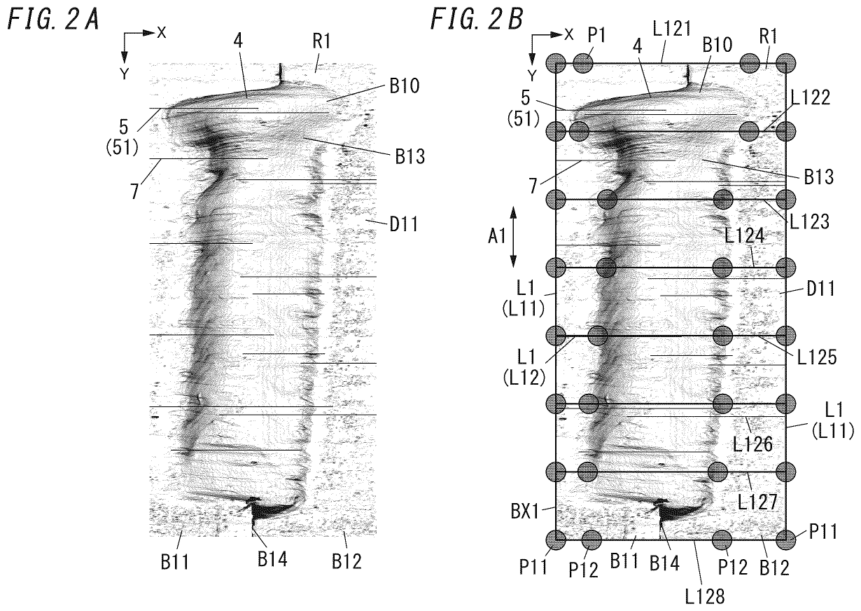

A data creation system 1 according to an exemplary embodiment creates, based on first image data D11, second image data D12 for use as learning data to generate a learned model M1 about an object 4 (refer to FIGS. 2A and 2B), as shown in FIG. 1. In other words, the second image data D12 is learning data for use to generate a model by machine learning. As used herein, the “model” refers to a program designed to estimate, in response to input of data about an object to be recognized (object 4), the condition of the object to be recognized and output a result of estimation (recognition result). Also, as used herein, the “learned model” refers to a model about which machine learning using learning data is completed. Furthermore, the “learning data (set)” refers to a data set including, in combination, input information (image data D1) to be entered for a model and a label attached to the input information, i.e., so-called “training data.” That is to say, in this embodiment, the learned model M1 is a model about which machine learning has been done by supervised learning.

In this embodiment, the object 4 as an object to be recognized may be, for example, a bead B10 as shown in FIGS. 2A and 2B. The bead B10 is formed, when two or more welding base materials (e.g., a first base metal B11 and a second base metal B12 in this example) are welded together via a welding material B13, in the boundary B14 (welding spot) between the first base metal B11 and the second base metal B12. The dimensions and shape of the bead B10 depend mainly on the welding material B13. Thus, when object to be recognized image data D3 covering the bead B10 is entered, the learned model M1 estimates the condition (particular condition) of the bead B10 and outputs a result of estimation. Specifically, the learned model M1 outputs, as the result of estimation, information indicating whether the bead B10 is a defective product or a non-defective (i.e., good) product and information about the type of the defect if the bead B10 is a defective product. That is to say, the learned model M1 is used to determine whether the bead B10 is a good product or not. In other words, the learned model M1 is used to conduct a weld appearance test to determine whether welding has been done properly.

Decision about whether the bead B10 is good or defective may be made depending on, for example, whether the length of the bead B10, the height of the bead B10, the angle of elevation of the bead B10, the throat depth of the bead B10, the excess metal of the bead B10, and the misalignment of the welding spot of the bead B10 (including the degree of shift of the beginning of the bead B10) fall within their respective tolerance ranges. For example, if at least one of these parameters enumerated above fails to fall within its tolerance range, then the bead B10 is determined to be a defective product. Alternatively, decision about whether the bead B10 is good or defective may also be made depending on, for example, whether the bead B10 has any undercut, whether the bead B10 has any pit, whether the bead B10 has any sputter, and whether the bead B10 has any projection. For example, if at least one of these imperfections enumerated above is spotted, then the bead B10 is determined to be a defective product.

To make machine learning about a model, a great many image data items about the objects to be recognized, including defective products, need to be collected as learning data. However, if the objects to be recognized turn out to be defective at a low frequency of occurrence, then learning data required to generate a learned model M1 with high recognizability tends to be short. Thus, to overcome this problem, machine learning about a model may be made with the number of learning data items increased by performing data augmentation processing about learning data (hereinafter referred to as either “first image data D11” or “original learning data”) acquired by actually shooting the bead B10 using an image capture device (line sensor camera 6). As used herein, the data augmentation processing refers to the processing of expanding learning data by subjecting the learning data to various types of processing (transformation processing) such as translation, scaling up or down (expansion or contraction), rotation, flipping, and addition of noise, for example.

The first image data D11 may be, for example, distance image data. In this case, the first image data D11 as original learning data may have, depending on the performance of an image capture device (line sensor camera 6) including a distance image sensor during the scanning operation, a large number of thin straight stripes 7 (refer to FIGS. 2A and 2B). In FIGS. 2A and 2B and other drawings, only some of the large number of stripes 7 are schematically indicated by solid lines to indicate the directivities of those stripes 7 clearly for the sake of convenience of description. However, those solid lines do not indicate the exact positions and number of those stripes 7 and should not be construed as limiting.

Such “stripes” may be caused by, for example, a camera shake due to hand tremors of an articulated robot holding the line sensor camera 6. When the line sensor camera 6 that has scanned one line of an object of shooting starts to scan the next line, the distance to the object of shooting may be slightly different due to the camera shake. As a result, a “stripe” surfaces as a difference (in the distance from the distance image sensor to the object 4) in pixel value within the image data at the boundary between these lines of scanning (scan lines). The width of each scan line varies depending on, for example, the resolution of the robot in the feed direction but may be, for example, a few split millimeters.

If the shape of the object 4 were deformed by data augmentation processing with respect to first image data D11 with a lot of thin straight stripes 7, then those straight stripes 7 could also be deformed into an unintended distorted shape. Consequently, a learned model reflecting the distorted stripes 7 could be generated. Nevertheless, the object to be recognized image data D3 that may be input actually has no such distorted stripes 7, thus possibly causing a decline in the performance of recognizing the object 4 in the inference phase.

The data creation system 1 according to this embodiment includes a deformer 12 that generates, based on first image data D11 including a pixel region R1 (refer to FIG. 2A) representing the object 4, second image data D12 by deforming the shape of the object 4 as shown in FIG. 1. The deformer 12 generates the second image data D12 to maintain a predetermined feature of the first image data D11 before and after the shape of the object 4 is deformed.

In this example, the predetermined feature may include, as an example, at least one linear feature 5 included in the first image data D11. In particular, in this embodiment, the linear feature 5 includes a straight feature 51. A straight stripe 7 concerning the boundary between two adjacent scan lines corresponds to such a straight feature 51.

In short, the first image data D11 includes a region that can exist in the real world even after the contour or any other shape of the object 4 has been deformed, for example, and a region that cannot exist in the real world once the shape of the object 4 has been deformed. The straight stripe 7 described above is an example of the latter region.

According to this embodiment, the predetermined feature is maintained before and after the shape of the object 4 is deformed, thus enabling creating pseudo data (by data augmentation, for example) which is even closer to image data that can exist in the real world. Consequently, this contributes to reducing the chances of causing a decline in the performance of recognizing the object 4.

Also, a learning system 2 (refer to FIG. 1) according to this embodiment generates a learned model M1 using a learning data set including learning data as the second image data D12 created by the data creation system 1. This enables providing a learning system 2 contributing to reducing the chances of causing a decline in the performance of recognizing the object 4. The learning data for use to generate the learned model M1 may include not only the second image data D12 (augmented data) but also the original first image data D11 as well. In other words, the image data D1 according to this embodiment includes at least the second image data D12 and may include both the first image data D11 and the second image data D12.

An estimation system 3 (refer to FIG. 1) according to this embodiment estimates a particular condition of an object 4 (e.g., bead B10 in this example) as the object to be recognized using the learned model M1 generated by the learning system 2. This enables providing an estimation system 3 contributing to reducing the chances of causing a decline in the performance of recognizing the object 4.

A data creation method according to this embodiment is a method for creating, based on first image data D11, second image data D12 for use as learning data to generate a learned model M1 about an object 4. The data creation method includes a deforming step including generating, based on the first image data D11 including a pixel region R1 representing the object 4, the second image data D12 by deforming a shape of the object 4. The deforming step includes generating the second image data D12 to maintain a predetermined feature of the first image data D11 before and after the shape of the object 4 is deformed. This enables providing a data creation method contributing to reducing the chances of causing a decline in the performance of recognizing the object 4. The data creation method is used on a computer system (data creation system 1). That is to say, the data creation method is also implementable as a program. A program according to this embodiment is designed to cause one or more processors to perform the data creation method according to this embodiment.

(2) Details

Next, an overall system including the data creation system 1 according to this embodiment (hereinafter referred to as an “evaluation system 100”) will now be described in detail with reference to FIGS. 1-5.

(2.1) Overall Configuration

As shown in FIG. 1, the evaluation system 100 includes the data creation system 1, the learning system 2, the estimation system 3, and one or more line sensor cameras 6 (only one of which is shown in FIG. 1).

The data creation system 1, the learning system 2, and the estimation system 3 are supposed to be implemented as, for example, a server. The “server” as used herein is supposed to be implemented as a single server device. That is to say, major functions of the data creation system 1, the learning system 2, and the estimation system 3 are supposed to be provided for a single server device.

Alternatively, the “server” may also be implemented as a plurality of server devices. Specifically, the functions of the data creation system 1, the learning system 2, and the estimation system 3 may be provided for three different server devices, respectively. Alternatively, two out of these three systems may be provided for a single server device. Optionally, those server devices may form a cloud computing system, for example.

Furthermore, the server device may be installed either inside a factory as a place where welding is performed or outside the factory (e.g., at a service headquarters), whichever is appropriate. If the respective functions of the data creation system 1, the learning system 2, and the estimation system 3 are provided for three different server devices, then each of these server devices is preferably connected to the other server devices to be ready to communicate with the other server devices.

The data creation system 1 is configured to create image data D1 for use as learning data to generate the learned model M1 about the object 4. As used herein, to “create learning data” may refer to not only generating new learning data separately from the original learning data but also generating new learning data by updating the original learning data.

The learned model M1 as used herein may include, for example, either a model that uses a neural network or a model generated by deep learning using a multilayer neural network. Examples of the neural networks may include a convolutional neural network (CNN) and a Bayesian neural network (BNN). The learned model M1 may be implemented by, for example, installing a learned neural network into an integrated circuit such as an application specific integrated circuit (ASIC) or a field-programmable gate array (FPGA). However, the learned model M1 does not have to be a model generated by deep learning. Alternatively, the learned model M1 may also be a model generated by a support vector machine or a decision tree, for example.

In this embodiment, the data creation system 1 has the function of expanding the learning data items by performing data augmentation processing on the original learning data (first image data D11) as described above. In the following description, a person who uses the evaluation system 100 including the data creation system 1 will be hereinafter simply referred to as a “user.” The user may be, for example, an operator who monitors a manufacturing process such as a welding process step in a factory or a chief administrator.

As shown in FIG. 1 the data creation system 1 includes a processor 10, a communications interface 13, a display device 14, and an operating member 15.

In the example illustrated in FIG. 1, a storage device for storing the learning data (image data D1) is provided outside of the data creation system 1. However, this is only an example and should not be construed as limiting. Alternatively, the data creation system 1 may further include a storage device. In that case, the storage device may also be a memory built in the processor 10. The storage device for storing the image data D1 includes a programmable nonvolatile memory such as an electrically erasable programmable read-only memory (EEPROM).

Optionally, some functions of the data creation system 1 may be distributed in a telecommunications device with the capability of communicating with the server. Examples of the “telecommunications devices” as used herein may include personal computers (including laptop computers and desktop computers) and mobile telecommunications devices such as smartphones and tablet computers. In this embodiment, the functions of the display device 14 and the operating member 15 are provided for the telecommunications device to be used by the user. A dedicated application software program allowing the telecommunications device to communicate with the server is installed in advance in the telecommunications device.

The processor 10 may be implemented as a computer system including one or more processors (microprocessors) and one or more memories. That is to say, the one or more processors may perform the functions of the processor 10 by executing one or more programs (applications) stored in the one or more memories. In this embodiment, the program is stored in advance in the memory of the processor 10. Alternatively, the program may also be downloaded via a telecommunications line such as the Internet or distributed after having been stored in a non-transitory storage medium such as a memory card.

The processor 10 performs the processing of controlling the communications interface 13, the display device 14, and the operating member 15. The functions of the processor 10 are supposed to be performed by the server. In addition, the processor 10 also has the function of performing image processing. As shown in FIG. 1, the processor 10 includes an acquirer 11 and a deformer 12. The acquirer 11 and the deformer 12 will be described in detail later in the next section.

The display device 14 may be implemented as either a liquid crystal display or an organic electroluminescent (EL) display. The display device 14 is provided for the telecommunications device as described above. Optionally, the display device 14 may also be a touchscreen panel display. The display device 14 displays (outputs) information about the first image data D11 and the second image data D12. In addition, the display device 14 also displays various types of information about the generation of learning data besides the first image data D11 and the second image data D12.

The communications interface 13 is a communications interface for communicating with one or more line sensor cameras 6 either directly or indirectly via, for example, another server having the function of a production management system. In this embodiment, the function of the communications interface 13, as well as the function of the processor 10, is supposed to be provided for the same server. However, this is only an example and should not be construed as limiting. Alternatively, the function of the communications interface 13 may also be provided for the telecommunications device, for example. The communications interface 13 receives, from the line sensor camera 6, the first image data D11 as the original learning data.

The first image data D11 may be, for example, distance image data, as described above, and includes a pixel region R1 representing the object 4. Alternatively, the first image data D11 may also be luminance image data. As described above, the object 4 may be, for example, the bead B10 formed, when the first base metal B11 and the second base metal B12 are welded together via the welding material B13, in the boundary B14 between the first base metal B11 and the second base metal B12. That is to say, the first image data D11 is data captured by a distance image sensor of the line sensor camera 6 and including the pixel region R1 representing the bead B10.

The first image data D11 is chosen as the target of the data augmentation processing in accordance with, for example, the user's command from a great many image data items about the object 4 shot with the line sensor camera 6. The evaluation system 100 preferably includes a user interface (which may be the operating member 15) that accepts the user's command about his or her choice.

Examples of the operating member 15 include a mouse, a keyboard, and a pointing device. The operating member 15 may be provided, for example, for the telecommunications device to be used by the user as described above. If the display device 14 is a touchscreen panel display of the telecommunications device, then the display device 14 may also have the function of the operating member 15.

The learning system 2 generates the learned model M1 using a learning data set including a plurality of image data items D1 (including a plurality of second image data items D12) created by the data creation system 1. The learning data set is generated by attaching a label indicating either a good product or a defective product or a label indicating the type and location of the defect as for the defective product to each of the plurality of image data items D1. Examples of the types of defects include undercut, pit, and sputter. The work of attaching the label is performed on the evaluation system 100 by the user via a user interface such as the operating member 15. In one variation, the work of attaching the label may also be performed by a learned model having the function of attaching a label to the image data D1. The learning system 2 generates the learned model M1 by making, using the learning data set, machine learning about the conditions (including a good condition, a bad condition, the type of the defect, and the location of the defect) of the object 4 (e.g., the bead B10).

Optionally, the learning system 2 may attempt to improve the performance of the learned model M1 by making re-learning using a learning data set including newly acquired learning data. For example, if a new type of defect is found in the object 4 (e.g., the bead B10), then the learning system 2 may be made to do re-learning about the new type of defect.

The estimation system 3 estimates, using the learned model M1 generated by the learning system 2, the particular conditions (including a good condition, a bad condition, the type of the defect, and the location of the defect) of the object 4 as the object to be recognized. The estimation system 3 is configured to be ready to communicate with one or more line sensor cameras 6 either directly or indirectly via, for example, another server having the function of a production management system. The estimation system 3 receives object to be recognized image data D3 generated by shooting the bead B10, which has been formed by actually going through a welding process step, with the line sensor camera 6.

The estimation system 3 determines, based on the learned model M1, whether the object 4 shot in the object to be recognized image data D3 is a good product or a defective product and estimates, if the object 4 is a defective product, the type and location of the defect. The estimation system 3 outputs the result of recognition (i.e., the result of estimation) about the object to be recognized image data D3 to, for example, the telecommunications device used by the user or the production management system. This allows the user to check the result of estimation through the telecommunications device. Optionally, the production management system may control the production facility to discard a welded part that has been determined, based on the result of estimation acquired by the production management system, to be a defective product before the part is transported and subjected to the next processing step.

(2.2) Data Augmentation Processing

The processor 10 has the function of performing “deformation processing” as a type of data augmentation processing. Specifically, the processor 10 includes the acquirer 11 and the deformer 12 as shown in FIG. 1.

The acquirer 11 is configured to acquire information about a predetermined feature (hereinafter referred to as “maintenance information”). In this example, the predetermined feature includes at least one linear feature 5 included in the first image data D11 (refer to FIG. 2A) and the linear feature 5 includes a straight feature 51. As described above, the straight stripe 7 concerning the boundary between two adjacent scan lines corresponds to the straight feature 51. That is to say, the straight feature 51 is a feature concerning the boundary between a plurality of scan lines on the first image data D11 depending on the line sensor camera 6 that has shot the object 4.

In FIG. 2A, the first base metal B11 and the second base metal B12 are arranged side by side along the X-axis (i.e., laterally) and the bead B10 is formed to be elongate along the Y-axis (i.e., vertically). In FIG. 2A, a large number of straight stripes 7 extend along the X-axis. That is to say, in this embodiment, the predetermined feature includes a plurality of linear features 5, in particular, a plurality of straight features 51. The plurality of linear features 5 are correlated to each other in terms of linearity. In this example, the plurality of straight features 51 has such linearity that makes the straight features 51 substantially parallel to each other.

The acquirer 11 acquires the maintenance information in accordance with an operating command entered by the user via the operating member 15. For example, the user may check, with the naked eye, the first image data D11 displayed on the screen by the display device 14 to determine the respective directions, locations, and other parameters of a large number of straight stripes 7 involved with the scan lines. The user enters, using the operating member 15, an operating command to specify the direction of the stripes 7 (e.g., their tilt with respect to the X-axis). That is to say, the maintenance information includes information specifying the direction (e.g., the direction aligned with the X-axis in this case) of the stripes 7. Optionally, the maintenance information may include function data representing the linearity of the stripes 7. Alternatively, the maintenance information may include information directly specifying the location coordinates of a pixel region representing one or more stripes 7 to maintain. In one specific example, to directly specify a stripe 7, first, the user selects two points included in the stripe 7 using a mouse pointer and specifies the two points by clicking the mouse. The acquirer 11 calculates a straight line passing through the two points thus specified and superimposes the straight line thus calculated on the first image data D11. The display device 14 displays the first image data D11 on which the straight line is superimposed and an end button. The user checks the straight line displayed and, when there is no problem, selects the end button using the mouse pointer and clicks the mouse. The acquirer 11 acquires the straight line thus calculated as the maintenance information. This allows the user to directly specify the stripe 7 to maintain.

Optionally, the processor 10 may perform the function of an extractor for automatically extracting, from the first image data D11, a pixel region representing the stripe 7 (i.e., a feature quantity about the stripe 7). The extractor may, for example, store information to locate the stripe 7 in the memory of the processor 10 and automatically extracts the maintenance information from the first image data D11 by reference to the information. In that case, the acquirer 11 acquires the maintenance information from the extractor. This configuration saves the user the trouble of specifying the direction and other parameters of the stripe 7.

The deformer 12 is configured to generate, based on the first image data D11, the second image data D12 by deforming the shape of the object 4 (e.g., the bead B10). That is to say, the second image data D12 is generated by deforming the shape of the bead B10 in the first image data D11 by image processing (such as projective transformation or affine transformation). The deformer 12 generates the second image data D12 to maintain a predetermined feature of the first image data D11 before and after the shape of the object 4 is deformed. The deformer 12 generates the second image data D12 in accordance with the maintenance information acquired by the acquirer 11.

In this example, the deformer 12 deforms the shape of the bead B10 (through deformation processing) to maintain the straight feature 51 in accordance with the maintenance information acquired by the acquirer 11.

Next, the deformation processing will be described more specifically. The deformer 12 is configured to set a plurality of virtual lines L1 (straight lines) and a plurality of reference points P1 on the first image data D11 as shown in FIG. 2B and then cause the following two types of deformations (hereinafter referred to as a first deformation and a second deformation, respectively). Specifically, the deformer 12 sets the plurality of reference points P1 on the virtual lines (i.e., second lines L12 to be described later) and moves at least one reference point P1 out of the plurality of reference points P1, thereby deforming the shape of the object 4.

The plurality of virtual lines L1 includes a pair of first lines L11 each of which is parallel to the Y-axis, and eight second lines L12, each of which is parallel to the X-axis. The deformer 12 sets the eight second lines L12 such that those second lines L12 are arranged at regular intervals along the Y-axis. Note that the number of the virtual lines L1 is not limited to any particular number. The interval between two second lines L12 which are adjacent to each other in the Y-axis direction may be set in advance in a storage device (e.g., the memory of the processor 10) or changed in accordance with the user's command entered via the operating member 15, whichever is appropriate. Optionally, the number of the second lines L12 may be changed in response to the change of the interval setting. In the following description, the eight second lines L12 will be hereinafter sometimes referred to as second lines L121-L128, respectively, from top to bottom of FIG. 2B for the sake of convenience of description.

The deformer 12 according to this embodiment sets, in accordance with the maintenance information (straight feature 51), the direction of the eight second lines L12 to align the direction of the second lines L12 with the direction of the stripes 7 (e.g., direction aligned with the X-axis in this case).

In this example, the deformer 12 sets the direction of the virtual lines L1 such that the bead B10 is surrounded with the pair of first lines L11 and two second lines L121, L128 at both ends in the Y-axis direction out of the eight second lines L12. In the following description, the rectangular frame defined by the pair of first lines L11 and the two second lines L121, L128 will be hereinafter referred to as a “bounding box BX1” (refer to FIG. 2B). The deformer 12 determines, based on a difference in pixel value, the contour shape of the bead B10. The deformer 12 determines the contour shape of the bead B10 by image processing such as edge detection processing. Then, the deformer 12 defines the bounding box BX1 such that the second lines L12 not only are aligned with the direction of the stripes 7 but also surround the bead B10 in its entirety (refer to FIG. 2B).

The plurality of reference points P1 includes sixteen first points P11, which are set at respective intersections between the pair of first lines L11 and the eight second lines L12, and sixteen second points P12, which are set at respective intersections between the eight second lines L12 and the contour of the bead B10. Strictly speaking, there is no intersection between the second line L121 and the contour of the bead B10, and therefore, the second points P12 of the second line L121 are set at the same locations in the X-axis direction as the second points P12 of the second line L122. Likewise, there is no intersection between the second line L128 and the contour of the bead B10, and therefore, the second points P12 of the second line L128 are set at the same locations in the X-axis direction as the second points P12 of the second line L127.

In this embodiment, the deformer 12 may perform the deformation processing to, for example, prevent the contour of the bead B10 from overreaching the bounding box BX1 thus defined.

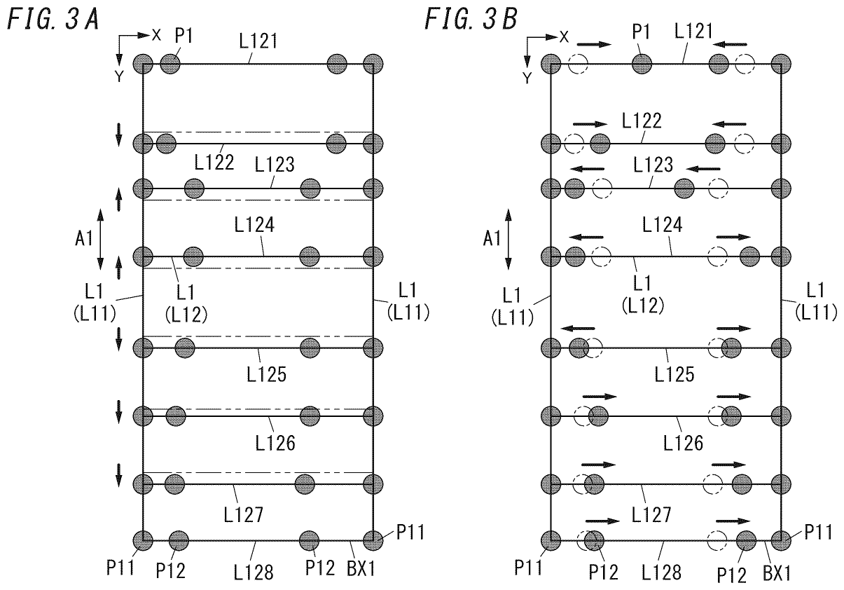

The first deformation is expansion or contraction to either increase or decrease the distance between two adjacent second lines L12 as shown in FIG. 3A. In the example shown in FIG. 3A, the deformer 12 deforms the object 4 to make the distance between the second lines L121, L122 longer than the one shown in FIG. 2B, i.e., to expand a region, falling within the range between the second lines L121 and L122, of the object 4 along the Y-axis. When expanding (or extending) that region of the object 4, the deformer 12 makes pixel interpolation as appropriate by linear interpolation, for example. In this case, the second line L122 moves, along with the four reference points P1 on the second line L122, toward the positive side of the Y-axis (i.e., moves downward). In addition, in the example shown in FIG. 3A, the deformer 12 makes the distance between the second lines L122 and L123 shorter than the one shown in FIG. 2B. That is to say, the deformer 12 deforms the object 4 such that the region, falling within the range between the second lines L122, L123, of the object 4 contracts along the Y-axis. In this case, the second line L123 moves, along with the four reference points P1 on the second line L123, toward the negative side of the Y-axis (i.e., moves upward).

As for the other second lines L12, in the example shown in FIG. 3A, the second line L124 moves, along with the four reference points P1 on the line L124, toward the negative side of the Y-axis (i.e., moves upward). Each of the other second lines L125, L126, and L127 moves, along with the four reference points P1 on the line, toward the positive side of the Y-axis (i.e., moves downward).

In other words, the deformer 12 generates second image data D12 by deforming the shape of the object 4 in the arrangement direction A1 (i.e., Y-axis) in which two or more virtual lines (second lines L12) aligned with the linear feature 5 are arranged. Thus, the linearity of the linear feature 5 is maintained.

The parameters specifying the exact degree of expansion or contraction to apply may be set in advance in a storage device (such as the memory of the processor 10), automatically set at random by the processor 10, or set in accordance with the user's command entered via the operating member 15, whichever is appropriate.

The second deformation is caused by moving at least one reference point P1 (e.g., two second points P12 to be set at the intersections with the contour of the bead B10 in this example) out of the four reference points P1 on each second line L12 along the second line L12 as shown in FIG. 3B. That is to say, the deformer 12 generates second image data D12 by deforming the shape of the object 4 along one or more virtual lines (e.g., the second line L12) aligned with the linear feature 5 (e.g., the straight feature 51 in this example). Thus, the second deformation is deformation that maintains the linearity along the linear feature 5. The second deformation enables maintaining the linearity of the linear feature 5 by performing, for example, two-dimensional projective transformation on the seven rectangular regions formed by the pair of first lines L11 and the eight second lines L12 and thereby transforming each of those seven rectangular regions into a trapezoidal region.

In the example shown in FIG. 3B, the deformer 12 deforms the object 4 such that the two second points P12 on each of the second lines L121, L122 move toward each other, i.e., a region, falling within the range between those two second points P12, of the object 4 contracts along the X-axis.

Also, in the example shown in FIG. 3B, the deformer 12 deforms the object 4 such that the two second points P12 on the second line L123 each move toward the negative side of the X-axis, i.e., a region, falling within the range between those two second points P12, of the object 4 moves toward the negative side of the X-axis.

Furthermore, in the example shown in FIG. 3B, the deformer 12 deforms the object 4 such that the two second points P12 on each of the second lines L124, L125 move away from each other, i.e., a region, falling within the range between those two second points P12, of the object 4 expands along the X-axis.

Furthermore, in the example shown in FIG. 3B, the deformer 12 deforms the object 4 such that the two second points P12 on each of the second lines L126-L128 each move toward the positive side of the X-axis, i.e., a region, falling within the range between those two second points P12, of the object 4 moves toward the positive side of the X-axis.

The magnitude of movement of each reference point P1 (second point P12) on the second line L12 may be set in advance in a storage device (such as the memory of the processor 10), automatically set at random by the processor 10, or set in accordance with the user's command entered via the operating member 15, whichever is appropriate. An upper limit value (e.g., 50% of the length of the second line L12) is preferably set with respect to the magnitude of movement.

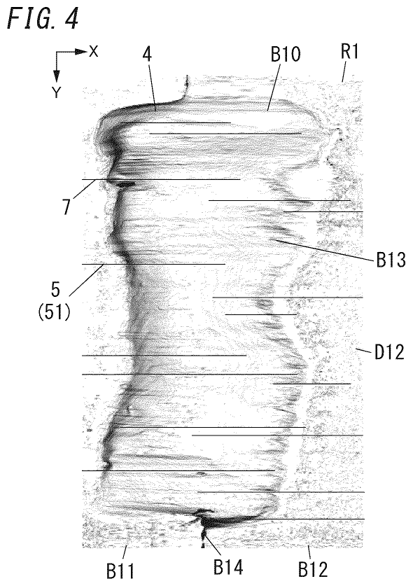

FIG. 4 is an exemplary plan view of the second image data D12 created through the first deformation and the second deformation.

In this embodiment, the deformer 12 moves at least one reference point P1 while maintaining the order of arrangement of the plurality of reference points P1 set on each virtual line (second line L12). That is to say, the deformer 12 moves the reference point P1 to prevent one of the two second points P12 on a second line L12 from moving beyond the other second point P12 to the opposite side or moving beyond the first point P11 to the opposite side, for example. Deforming the object 4 while maintaining the order of arrangement of the plurality of reference points P1 reduces the chances of the second image data D12 becoming significantly different from image data that can exist in the real world.

In this embodiment, the deformer 12 is supposed to create the second image data D12 by causing both the first deformation and the second deformation. However, this is only an example and should not be construed as limiting. Alternatively, the deformer 12 may cause only one of the first deformation or the second deformation. Furthermore, in the embodiment described above, the deformer 12 is supposed to cause the first deformation and the second deformation in this order. However, these two types of processing may be performed in a different order. That is to say, the second deformation may be caused first, and then the first deformation may be caused. The data creation system 1 preferably allows the user to enter a command, via the operating member 15, for example, specifying, not only either the first deformation or the second deformation is to be caused or both the first deformation and the second deformation are to be caused, but the order in which at least one of these two types of processing is performed.

The deformer 12 may create the second image data D12 by performing additional image processing such as rotation or flipping besides at least one of the first deformation or the second deformation.

The label attached to the second image data D12 (indicating a particular condition of the object 4 as an object to be recognized) may be the same as the label attached in advance to the first image data D11 (indicating a particular condition of the object 4). For example, if the label attached to the first image data D11 (indicating the particular condition of the object 4) is “good product,” then the label attached to the second image data D12 (indicating the particular condition of the object 4) may also be good product. Also, if a particular condition is allocated to a particular region (i.e., pixel region representing the object 4) of the first image data D11, then the same particular condition may also be allocated to a particular region of the second image data D12 after the deformation. For example, if the particular condition (i.e., the type of defect) of the particular region of the first image data 11 is sputter, then the particular condition of the particular region of the second image data D12 after the deformation may also be regarded as sputter.

(2.3) Operation

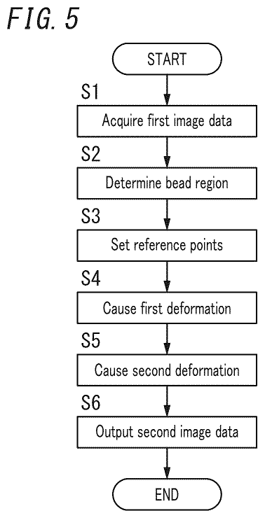

Next, an exemplary operation of the data creation system 1 will be described with reference to FIG. 5. Note that the procedure of operation to be described below is only an example and should not be construed as limiting.

First, to perform data augmentation processing, the processor 10 of the data creation system 1 acquires first image data D11 as original learning data (in S1). The first image data D11 may be, for example, data generated by shooting the bead B10 in a “defective” condition.

The processor 10 locates a pixel region R1 representing the bead B10 in the first image data D11 and defines a bounding box BX1 (i.e., determines the bead region in S2). Then, the processor 10 sets, based on the bounding box BX1, a plurality of virtual lines L1 (including the first lines L1 and the second lines L12) and further sets a plurality of reference points P1 on the respective second lines L12 (in S3).

Then, the processor 10 performs, on the pixel region R1 representing the bead B10, first deformation (processing) of expanding or contracting the pixel region R1 in the arrangement direction A1 of the plurality of second lines L12 (in S4).

Thereafter, the processor 10 further performs, on the pixel region R1 that has gone through the first deformation, second deformation (processing) of deforming the pixel region R1 by moving, along the second lines L12, a plurality of reference points P1 (second points P12) that have been set on the plurality of second lines L12 (in S5).

Second image data D12 (refer to FIG. 4) is generated through the first and second deformations. The processor 10 outputs the second image data D12 thus generated (in S6). The same label “defective” as the original first image data D11 is attached to the second image data D12, which is then stored as learning data (image data D1) in the storage device.

[Advantages]

As can be seen from the foregoing description, the data creation system 1 according to this embodiment maintains the straight feature 51 as a predetermined feature (e.g., the stripes 7 involved with the scan lines) before and after the shape of the object 4 is deformed. This enables creating (by data augmentation, for example) data about the object 4 (e.g., the bead B10) as the second image data D12 that has gone through deformation while maintaining the straight feature 51 (stripes 7) as if the object 4 were actually shot with the line sensor camera 6.

Deforming the shape of the object 4 without maintaining the straight feature 51 (e.g., the stripes 7) would leave the straight feature 51 with a significantly decreased degree of linearity in the image data. Such an image cannot exist in the object to be recognized image data D3 that has been actually shot with the line sensor camera 6.

In contrast, the data creation system 1 according to this embodiment enables creating pseudo data that is even closer to image data that can exist in the real world. Estimating the condition of the object 4 in the object to be recognized image data D3 using a learned model M1 that has been generated using such second image data D12 as learning data reduces the chances of recognizing the condition of the object 4 erroneously due to the significant decrease in the degree of linearity of the straight feature 51. Consequently, this contributes to reducing the chances of causing a decline in the performance of recognizing the object 4.

In addition, this also enables preparing a wide variety of learning data while maintaining the linearity of the straight feature 51. Specifically, this enables preparing learning data in which the shape of a good product or a defective product is deformed while maintaining the linearity of the straight feature 51.

Furthermore, the data creation system 1 includes the acquirer 11 that acquires information about the predetermined feature, thus enabling generating second image data D12 in accordance with an externally specified predetermined feature, for example. This increases the user friendliness. In particular, if the predetermined feature is the straight feature 51 (e.g., stripes 7), then the stripes 7 may vary depending on the resolution of the line sensor camera 6 installed in the welding place and the resolution in the feed direction of an articulated robot supporting the line sensor camera 6. Thus, the data creation system 1 is preferably configured to allow the user who actually uses the data creation system 1 to specify the predetermined feature through the operating member 15, for example.

Furthermore, in the embodiment described above, the deformer 12 deforms the shape of the object 4 along one or more second lines L12 aligned with the straight feature 51. This enables creating a wide variety of data that is even closer to image data that can exist in the real world.

Furthermore, in the embodiment described above, the deformer 12 deforms the shape of the object 4 in the arrangement direction A1 in which two or more second lines L12 aligned with the linear feature 5 are arranged. This enables creating a wide variety of data that is even closer to image data that can exist in the real world.

In particular, in the embodiment described above, the straight feature 51 is a feature (e.g., thin stripes 7) concerning the boundary between a plurality of scan lines on the first image data D11 depending on the line sensor camera 6. This may reduce the chances of the data created becoming significantly different from the image data that can exist in the real world due to deformation of the boundary between the plurality of scan lines.

(3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Also, the functions of the data creation system 1 according to the exemplary embodiment described above may also be implemented as a data creation method, a computer program, or a non-transitory storage medium on which the computer program is stored.

Next, variations of the exemplary embodiment will be enumerated one after another. Note that the variations to be described below may be adopted in combination as appropriate. In the following description, the exemplary embodiment described above will be hereinafter sometimes referred to as a “basic example.”

The data creation system 1 according to the present disclosure includes a computer system. The computer system may include a processor and a memory as principal hardware components thereof. The functions of the data creation system 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the data creation system 1 are aggregated together in a single housing. However, this is not an essential configuration for the data creation system 1. Alternatively, those constituent elements of the data creation system 1 may be distributed in multiple different housings.

Conversely, the plurality of functions of the data creation system 1 may be aggregated together in a single housing. Still alternatively, at least some functions of the data creation system 1 (e.g., some functions of the data creation system 1) may be implemented as a cloud computing system as well.

(3.1) First Variation

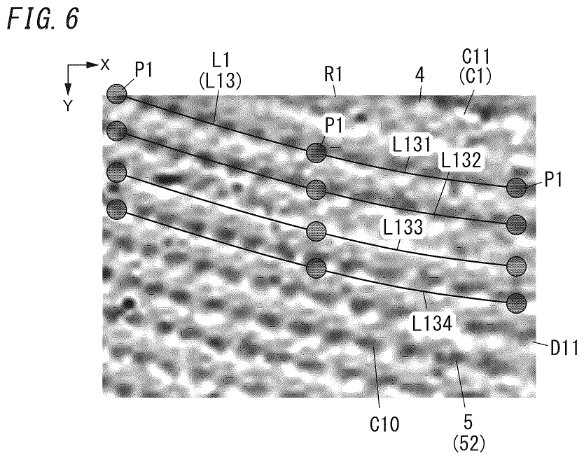

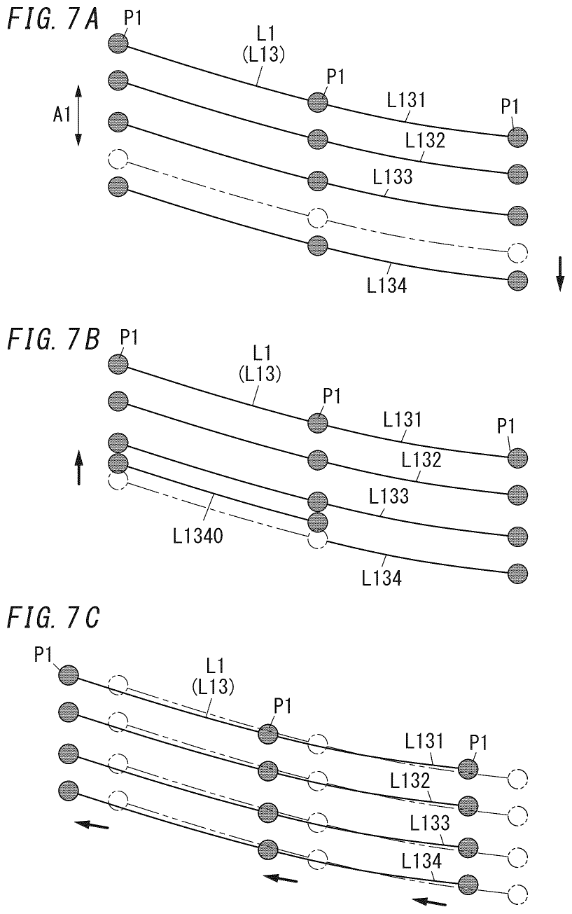

Next, a first variation of the present disclosure will be described with reference to FIG. 6 and FIGS. 7A-7C. In the following description, any constituent element, having substantially the same function as a counterpart of the data creation system 1 according to the basic example described above, will be designated by the same reference numeral as that counterpart's, and description thereof will be omitted herein as appropriate.

In the basic example described above, the object 4 as an object to be recognized is the welding bead B10. However, the object 4 does not have to be the bead B10. The learned model M1 does not have to be used to conduct a weld appearance test to determine whether welding has been done properly.

In this variation, the object 4 as an object to be recognized is a part (particular part C11) of a textile product C1 as shown in FIG. 6. In this variation, a learned model M1 generated by using learning data (image data D1) may be used to conduct an appearance test to determine whether sewing has been done properly by a sewing robot at a sewing factory, for example. FIG. 6 illustrates first image data D11 including a pixel region R1 representing a part of a textile product C1. The first image data D11 has a plurality of curvilinear pattern elements C10 representing a texture.

In this variation, the predetermined feature also includes a linear feature 5 as in the basic example described above but the linear feature 5 is supposed to have a curvilinear feature 52 (pattern element C10) unlike the basic example.

An acquirer 11 according to this variation acquires maintenance information in accordance with an operating command entered by the user via the operating member 15. For example, the user may check, with the naked eye, the first image data D11 displayed on the screen by the display device 14 to determine the direction, locations, and other parameters of a plurality of curvilinear pattern elements C10 representing a texture. The user determines the direction of a curvilinear pattern element C10 and enters, using the operating member 15, an operating command to specify the direction. That is to say, the maintenance information includes information specifying the direction of the curvilinear pattern element C10. Optionally, the maintenance information may be function data representing the curvilinear pattern elements C10. Alternatively, the maintenance information may include information directly specifying the location coordinates of the pixel region representing the curvilinear pattern element C10. In one specific example, to directly specify a curvilinear pattern element C10, first, the user selects two points included in the pattern element C10 using a mouse pointer and specifies the two points by clicking the mouse. The acquirer 11 calculates a straight line passing through the two points thus specified and superimposes the straight line thus calculated on the first image data D11. The display device 14 displays the first image data D11 on which the straight line is superimposed and an end button. The user checks the straight line displayed and, when there is no problem, selects the end button using the mouse pointer and clicks the mouse. The acquirer 11 acquires the straight line thus calculated as the maintenance information. On the other hand, if there is a difference between the straight line calculated and the pattern element C10, then the user further specifies a third point included in the pattern element C10. The acquirer 11 calculates a curve passing through the three points thus specified and superimposes the curve thus calculated on the first image data D11. The display device 14 displays the first image data D11 on which the curve is superimposed and an end button. The user checks the curve displayed and, when there is no problem, selects the end button and clicks the mouse. The acquirer 11 acquires the curve thus calculated as the maintenance information. On the other hand, if there is a difference between the curve calculated and the pattern element C10, then the user will further specify fourth, fifth, . . . and N^{th} points included in the pattern element C10 and the acquirer 11 will calculate respective curves in the same way after that. Optionally, the curve passing through N points thus specified may be calculated by, for example, an N^{th}-degree equation, a Bezier curve, or a spline curve. Alternatively, the display device 14 may also be configured to, when the user has specified only one point included in the pattern element C10, display a straight line or curve passing through the point.

Optionally, the processor 10 may perform the function of an extractor for automatically extracting, from the first image data D11, a pixel region representing the curvilinear pattern elements C10 (i.e., a feature quantity about the pattern elements C10). In that case, the acquirer 11 acquires the maintenance information from the extractor. This configuration saves the user the trouble of specifying the direction of the curvilinear pattern elements C10.

The deformer 12 is configured to generate, based on the first image data D11, the second image data D12 by deforming the shape of the object 4 (e.g., the particular part C11). The deformer 12 deforms the shape of the particular part C11 in accordance with the maintenance information acquired by the acquirer 11 to maintain the curvilinear feature 52 (i.e., performs deformation processing).

Next, the deformation processing according to this variation will be described more specifically. The deformer 12 is configured to set a plurality of virtual lines L1 (or curves) and a plurality of reference points P1 on the first image data D11 and then causes at least one of third, fourth, and fifth deformations.

The plurality of virtual lines L1 includes a plurality of (e.g., four in this example) curves L13 aligned with the plurality of curvilinear pattern elements C10. In this example, the four curves L13 are set to be aligned with the curvilinear pattern elements C10. However, this is only an example and should not be construed as limiting. Alternatively, the four curves L13 may also be set to be misaligned with the pattern elements C10 as long as the four curves L13 are parallel to the pattern elements C10. For example, the four curves L13 may be set at regular intervals. The interval may be set in advance in a storage device (e.g., the memory of the processor 10) or have its setting changed in accordance with a command entered by the user via the operating member 15. The number of the curves L13 may also be changed in response to the change of setting of the interval. In the following description, the four curves L13 will be hereinafter referred to as curves L131, L132, L133, and L134, respectively, from top to bottom for the sake of convenience of description.

The deformer 12 sets the direction of the four curves L13 in accordance with the maintenance information to make the four curves L13 aligned with the pattern elements C10. In addition, the deformer 12 also defines a bounding box BX1 to surround the particular part C11 specified by the user, for example. The deformer 12 further sets a plurality of (e.g., three in this example) reference points P1 at regular intervals on each curve L13.

The third deformation is expansion caused by, for example, translating the bottom curve L134 along the Y-axis (i.e., the arrangement direction A1 in which the four curves L13 are arranged) away from the curve L133 as shown in FIG. 7A. That is to say, the third deformation causes a region, interposed between the curves L133 and L134, of the object 4 to be expanded. In other words, the deformer 12 deforms the shape of the object 4 in the arrangement direction A1 in which two or more curves L13, aligned with the curvilinear feature 52, are arranged (i.e., in the direction aligned with the Y-axis). As a result, the curvilinearity of the curvilinear feature 52 may be maintained. The third deformation is used to increase the variety of the shapes of the object 4.

The fourth deformation is contraction caused by, for example, translating a line segment L1340 between two reference points P1 of the bottom curve L134 along the Y-axis toward the curve L133 as shown in FIG. 7B. That is to say, the fourth deformation causes a region, interposed between the curves L133 and the line segment L1340, of the object 4 to contract. As a result, the curvilinearity of the curvilinear feature 52 may be maintained. The fourth deformation is used to produce a defect (imperfection).

The fifth deformation causes, for example, all three reference points P1 on each curve L13 to move along the curve L13 toward the negative side of the X-axis as shown in FIG. 7C. That is to say, the fifth deformation causes a region, located between the plurality of curves L13, of the object 4 to move along the curves L13 toward the negative side of the X-axis. As a result, the curvilinearity of the curvilinear feature 52 may be maintained. The fifth deformation is used to increase the variety of the shapes of the object 4.

The deformer 12 creates the second image data D12 by causing at least one of the third, fourth, and fifth deformations. The user is preferably allowed to specify, by entering a command via the operating member 15, which of the third, fourth, and fifth deformation should be caused and change the type of deformation to cause. If two or more types of deformations need to be caused out of the third, fourth, and fifth deformations, the processing steps may be performed in any order without limitation.

The deformer 12 may create the second image data D12 by performing additional image processing such as rotation or flipping besides at least one of the third, fourth, and fifth deformations.

As for the curvilinear pattern elements C10 included in the object 4 itself, maintaining their feature as is done in this variation enables creating pseudo data that is even closer to image data that can exist in the real world. Consequently, this contributes to reducing the chances of causing a decline in the performance of recognizing the object 4.

(3.2) Second Variation

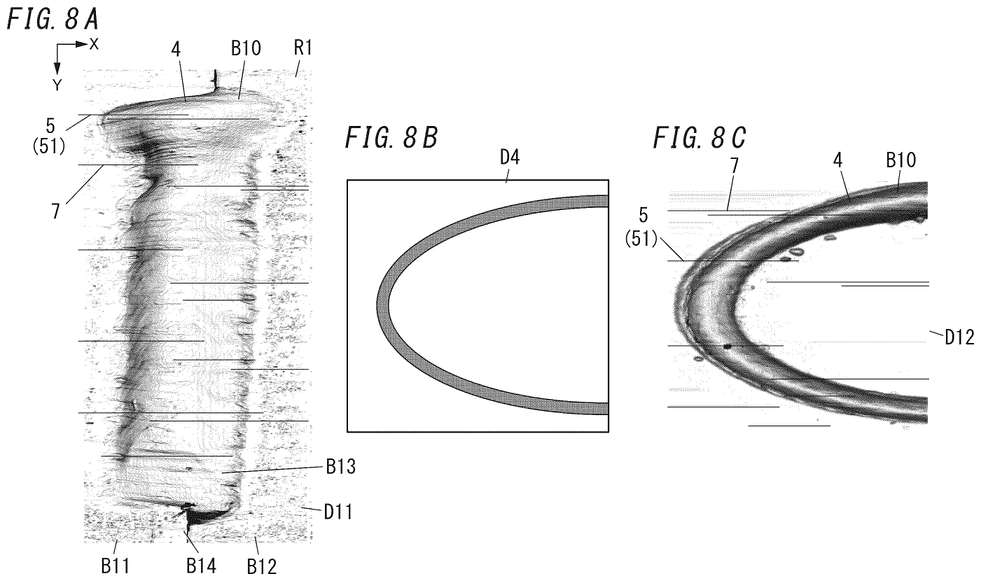

Next, a second variation of the present disclosure will be described with reference to FIGS. 8A-8C. In the following description, any constituent element, having substantially the same function as a counterpart of the data creation system 1 according to the basic example described above, will be designated by the same reference numeral as that counterpart's, and description thereof will be omitted herein as appropriate.

The data creation system 1 according to this variation has the capability of deforming the shape of the object 4 in accordance with externally input additional data D4, which is a difference from the basic example. Specifically, the acquirer 11 according to this variation acquires information specifying the contour shape of the object 4 deformed. The deformer 12 creates second image data D12 by deforming the shape of the object 4 into the contour shape.

In FIG. 8A, as in the basic example described above, the first image data D11 also includes a pixel region R1 representing a bead B10 as an object 4.

FIG. 8B shows the additional data D4 (e.g., image data such as a CG image) created arbitrarily by the user. In this example, the additional data D4 corresponds to information specifying the contour shape. The acquirer 11 of the processor 10 acquires the additional data D4 that has been externally input via the operating member 15, for example. Optionally, the additional data D4 may also be data created based on the image data that has been actually captured with the line sensor camera 6, for example. In the example shown in FIG. 8B, the additional data D4 is image data rendered in a generally C-shape. The additional data D4 does not have to be image data but may also be function data representing a certain linear shape, for example.

The deformer 12 according to this variation deforms the contour of the object 4 (e.g., the bead B10) in accordance with the additional data D4 acquired by the acquirer 11. In this variation, the deformer 12 deforms the shape of the bead B10 to make the contour of the bead B10 similar to the generally C-shape represented by the additional data D4 (refer to FIG. 8C). Nevertheless, the deformer 12 deforms the contour of the object 4 (e.g., the bead B10) in accordance with the additional data D4 while maintaining the predetermined feature (e.g., the stripes 7 produced by scan lines) as in the first and second variations of the basic example.

Deforming the object 4 in accordance with the additional data D4 as is done in this variation enables creating an even wider variety of learning data.

(3.3) Third Variation

In the data creation system 1, the processing device including the acquirer 11 and the processing device including the deformer 12 may be two different devices. For example, in the data creation system 1, the processing device (hereinafter referred to as a “first processing device”) 110 including the acquirer 11 and the processing device (hereinafter referred to as a “second processing device”) 120 that performs the rest of the processing may be two different devices.

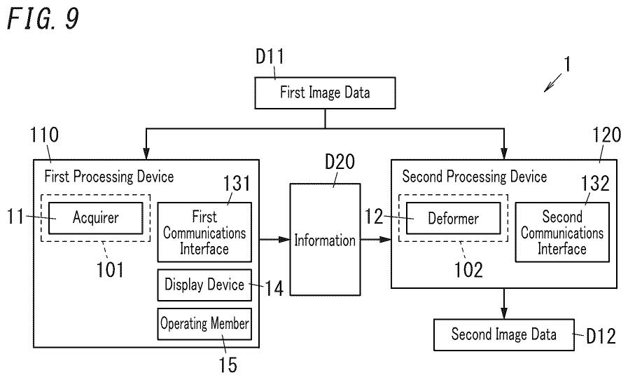

For example, as shown in FIG. 9, the first processing device 110 includes a processor (hereinafter referred to as a “first processor”) 101, a communications interface (hereinafter referred to as a “first communications interface”) 131, the display device 14, and the operating member 15. The first processor 101 of the first processing device 110 includes the acquirer 11.

The first communications interface 131 receives, from the line sensor camera 6, the first image data D11 as original learning data.

The acquirer 11 acquires, from the first image data D11, information about a predetermined feature (i.e., maintenance information).

The first communications interface 131 (transmitter) outputs (transmits) the information D20 about the predetermined feature, extracted by the acquirer 11, to the second processing device 120.

The second processing device 120 includes a processor (hereinafter referred to as a “second processor”) 102 and a communications interface (hereinafter referred to as a “second communications interface”) 132. The second processor 102 of the second processing device 120 includes the deformer 12.

The second communications interface 132 receives the first image data D11 from the line sensor camera 6.

The second communications interface 132 (receiver) receives the information D20 about the predetermined feature.

The deformer 12 generates, based on the first image data D11, second image data D12 by deforming the shape of the object 4. The deformer 12 generates the second image data D12 to maintain the predetermined feature of the first image data D11 before and after the shape of the object 4 is deformed.

The second processing device 120 may make, for example, the second communications interface 132 transmit the second image data D12 thus generated to the first processing device 110. In that case, the user may make the learning system 2 generate the learned model M1 using the second image data D12 thus received. This learned model M1 outputs, in response to the second image data D12, an estimation result similar to a situation where the first image data D11 is subjected to the estimation made about the particular condition of the object 4. The second image data D12 has been generated, based on the first image data D11, by deforming the shape of the object 4 to maintain the predetermined feature of the first image data D11.

The second processing device 120 may transmit the image data thus generated to an external server including a learning system. The learning system of the external server generates a learned model M1 using a learning data set including learning data as the second image data D12. This learned model M1 outputs, in response to the second image data D12, an estimation result similar to a situation where the first image data D11 is subjected to the estimation made about the particular condition of the object 4. The second image data D12 has been generated, based on the first image data D11, by deforming the shape of the object 4 to maintain the predetermined feature of the first image data D11. The user may receive, from the external server, the learned model M1 thus generated.

The same label as the one attached to the first image data D11 is attached to the second image data D12. Thus, making sufficient learning may make the learned model M1 a model that outputs, in response to the image data created by assigning the second feature to the second image data D12, an estimation result similar to a situation where the first image data D11 is subjected to the estimation made about the particular condition of the object 4.

(3.4) Other Variations

Next, other variations will be enumerated one after another.

The “image data” as used herein does not have to be image data acquired by an image sensor but may also be two-dimensional data such as a CG image or two-dimensional data formed by arranging multiple items of one-dimensional data acquired by a distance image sensor as already described for the basic example. Alternatively, the “image data” may also be three- or higher dimensional image data. Furthermore, the “pixels” as used herein do not have to be pixels of an image captured actually with an image sensor but may also be respective elements of two-dimensional data.

In the basic example described above, the first image data D11 is image data captured by making the line sensor camera 6 scan the object 4 (e.g., the bead B10) through the feed control performed by an articulated robot. Alternatively, the first image data D11 may also be image data captured by making an image capture device scan the object 4 put on a stage (such as an examining table) being moved.

Also, in the basic example described above, the first image data D11 is image data captured actually with an image capture device (line sensor camera 6). However, this is only an example and should not be construed as limiting. Alternatively, the first image data D11 may also be CG image data in which the stripes 7 involved with scan lines are rendered schematically.

Furthermore, in the basic example described above, the straight feature 51 is a feature (e.g., stripes 7) concerning the boundary between the scan lines. Alternatively, the straight feature 51 may also be a linear scratch left on the surface of a metallic plate.

Furthermore, in the basic example described above, the plurality of second points P12 are set at the respective intersections between the respective second lines L12 and the contour of the bead B10. However, this is only an example and should not be construed as limiting. Alternatively, the plurality of second points P12 may also be set at regular intervals on each second line L12. The predetermined interval may be specified by the user.

In the basic example described above, the straight feature 51 is individual straight lines (stripes 7). However, this is only an example and should not be construed as limiting. Alternatively, the linear feature 5 may also be a polygon (such as a triangle or a quadrangle) formed of a plurality of straight lines or even a pattern formed of multiple polygons.

In the first variation described above, the curvilinear feature 52 is a single curve (as a pattern element C10). However, this is only an example and should not be construed as limiting. Alternatively, the curvilinear feature 52 may include a circular or elliptical feature. For example, the curvilinear feature 52 may be a circle, an ellipse, or a pattern formed of multiple circles or ellipses. In that case, the acquirer 11 acquires information about, for example, the center positions of concentric circles. The center positions of concentric circles may be set in accordance with a command entered by the user via the operating member 15, for example. Alternatively, the processor 10 may automatically extract, by Hough transform, a circle from the image data captured.

Optionally, the linear feature 5 may also be a pattern as a mixture of a straight feature and a curvilinear feature. Alternatively, the linear feature 5 may also be a strip feature having at least a predetermined width.

The evaluation system 100 may include only some of the constituent elements of the data creation system 1. For example, the evaluation system 100 may include only the first processing device 110, out of the first processing device 110 and the second processing device 120 (refer to FIG. 9) of the data creation system 1, and the estimation system 3 (refer to FIG. 1). The functions of the first processing device 110 and the functions of the estimation system 3 may be provided for a single device. The evaluation system 100 may further include a learning system 2 (refer to FIG. 1) for generating the learned model M1. The functions of the first processing device 110, the functions of the learning system 2, and the functions of the estimation system 3 may be provided for a single device.

(4) Recapitulation

As can be seen from the foregoing description, a data creation system (1) according to a first aspect creates, based on first image data (D11), second image data (D12) for use as learning data to generate a learned model (M1) about an object (4). The data creation system (1) includes a deformer (12) that generates, based on the first image data (D11) including a pixel region (R1) representing the object (4), the second image data (D12) by deforming a shape of the object (4). The deformer (12) generates the second image data (D12) to maintain a predetermined feature of the first image data (D11) before and after the shape of the object (4) is deformed.

According to this aspect, a predetermined feature is maintained before and after the shape of the object (4) is deformed, thus enabling pseudo data creation (such as data augmentation) so that the data created is closer to image data that can exist in the real world. Consequently, this contributes to reducing the chances of causing a decline in the performance of recognizing the object (4).

A data creation system (1) according to a second aspect, which may be implemented in conjunction with the first aspect, further includes an acquirer (11) that acquires information about the predetermined feature. The deformer (12) generates the second image data (D12) in accordance with the information acquired by the acquirer (11).

According to this aspect, the second image data (D12) is generated based on, for example, a predetermined feature specified externally, thus improving user friendliness.

In a data creation system (1) according to a third aspect, which may be implemented in conjunction with the first or second aspect, the predetermined feature includes at least one linear feature (5) included in the first image data (D11). The deformer (12) generates the second image data (D12) by deforming the shape of the object (4) along one or more virtual lines (second lines L12) aligned with the linear feature (5).

This aspect enables creating a wide variety of data (by data augmentation, for example) that is even closer to image data that can exist in the real world.

In a data creation system (1) according to a fourth aspect, which may be implemented in conjunction with any one of the first to third aspects, the predetermined feature includes at least one linear feature (5) included in the first image data (D11). The deformer (12) generates the second image data (D12) by deforming the shape of the object (4) in an arrangement direction (A1) in which two or more virtual lines (second lines L12) are arranged along the linear feature (5).

This aspect enables creating a wide variety of data (by data augmentation, for example) that is even closer to image data that can exist in the real world.

In a data creation system (1) according to a fifth aspect, which may be implemented in conjunction with the third or fourth aspect, the linear feature (5) includes a straight feature (51).

This aspect may reduce the chances of data created becoming significantly different, due to deformation of the straight feature (51), from image data that can exist in the real world.

In a data creation system (1) according to a sixth aspect, which may be implemented in conjunction with the fifth aspect, the straight feature (51) concerns a boundary between a plurality of scan lines on the first image data (D11) depending on a line sensor camera (6) that has shot the object (4).

This aspect may reduce the chances of data created becoming significantly different, due to deformation of the boundary between the plurality of scan lines, from image data that can exist in the real world.

In a data creation system (1) according to a seventh aspect, which may be implemented in conjunction with any one of the third to sixth aspects, the linear feature (5) includes a curvilinear feature (52).

This aspect may reduce the chances of data created becoming significantly different, due to deformation of the curvilinear feature (52), from image data that can exist in the real world.

In a data creation system (1) according to an eighth aspect, which may be implemented in conjunction with the seventh aspect, the curvilinear feature (52) includes a circular feature or an elliptical feature.

This aspect may reduce the chances of data created becoming significantly different, due to deformation of the circular or elliptical feature, from image data that can exist in the real world.

In a data creation system (1) according to a ninth aspect, which may be implemented in conjunction with any one of the third to eighth aspects, the deformer (12) deforms the shape of the object (4) by setting a plurality of reference points (P1) on the virtual line (second line L12) and moving at least one reference point (P1) out of the plurality of reference points (P1).

This aspect enables creating a wide variety of data (by data augmentation, for example) that is even closer to image data that can exist in the real world.

In a data creation system (1) according to a tenth aspect, which may be implemented in conjunction with the ninth aspect, the deformer (12) moves the at least one reference point (P1) while maintaining an order of arrangement of the plurality of reference points (P1) set on the virtual line (second line L12).

This aspect may reduce the chances of data created becoming significantly different from image data that can exist in the real world.

A data creation system (1) according to an eleventh aspect, which may be implemented in conjunction with any one of the first to tenth aspects, further includes an acquirer (11) that acquires information specifying a contour shape of the object (4) that has been deformed. The deformer (12) generates the second image data (D12) by deforming the shape of the object (4) into the contour shape.

This aspect enables generating second image data (D12) easily by deforming the shape of the object (4) into a contour shape specified, thus increasing the variety of the image data.

A learning system (2) according to a twelfth aspect generates the learned model (M1) using a learning data set including the learning data as the second image data (D12) created by the data creation system (1) according to any one of the first to eleventh aspects.

This aspect enables providing a learning system (2) contributing to reducing the chances of causing a decline in the performance of recognizing the object (4).

An estimation system (3) according to a thirteenth aspect estimates a particular condition of the object (4) as an object to be recognized using the learned model (M1) generated by the learning system (2) according to the twelfth aspect.

This aspect enables providing an estimation system (3) contributing to reducing the chances of causing a decline in the performance of recognizing the object (4).

A data creation method according to a fourteenth aspect is a method for creating, based on first image data (D11), second image data (D12) for use as learning data to generate a learned model (M1) about an object (4). The data creation method includes a deforming step including generating, based on the first image data (D11) including a pixel region (R1) representing the object (4), the second image data (D12) by deforming a shape of the object (4). The deforming step includes generating the second image data (D12) to maintain a predetermined feature of the first image data (D11) before and after the shape of the object (4) is deformed.

This aspect enables providing a data creation method contributing to reducing the chances of causing a decline in the performance of recognizing the object (4).

A program according to a fifteenth aspect is designed to cause one or more processors to perform the data creation method according to the fourteenth aspect.

This aspect enables providing a function contributing to reducing the chances of causing a decline in the performance of recognizing the object (4).

A data creation system (1) according to a sixteenth aspect, which may be implemented in conjunction with the second aspect, includes a first processing device (110) and a second processing device (120). The first processing device (110) includes the acquirer (11). The second processing device (120) includes the deformer (12). The first processing device (110) transmits information about the predetermined feature to the second processing device (120).

This aspect enables contributing to reducing the chances of causing a decline in the performance of recognizing the object (4).

A processing device according to a seventeenth aspect functions as the first processing device (110) of the data creation system (1) according to the sixteenth aspect.

A processing device according to an eighteenth aspect functions as the second processing device (120) of the data creation system (1) according to the sixteenth aspect.

A learning system (2) according to a nineteenth aspect generates, using a learning data set including first image data (D11) as learning data, a learned model (M1) about an object (4). The first image data (D11) includes a pixel region (R1) representing the object (4). The learning system (2) outputs, in response to the second image data (D12), an estimation result similar to a situation where the first image data (D11) is subjected to estimation made about a particular condition of the object (4). The second image data (D12) is generated based on the first image data (D11) by deforming the shape of the object (4) to maintain a predetermined feature of the first image data (D11).

This aspect enables contributing to reducing the chances of causing a decline in the performance of recognizing the object (4).

An estimation system (3) according to a twentieth aspect estimates a particular condition of an object (4) as an object to be recognized. The estimation system (3) outputs, in response to the second image data (D12), an estimation result similar to a situation where the first image data (D11) is subjected to estimation made about the particular condition of the object (4). The second image data (D12) is generated based on the first image data (D11), including a pixel region (R1) representing the object (4), by deforming the shape of the object (4) to maintain a predetermined feature of the first image data (D11).

This aspect enables contributing to reducing the chances of causing a decline in the performance of recognizing the object (4).

Note that the constituent elements according to the second to eleventh aspects and the sixteenth aspect are not essential constituent elements for the data creation system (1) but may be omitted as appropriate.

### REFERENCE SIGNS LIST

1 Data Creation System
11 Acquirer
12 Deformer
2 Learning System
3 Estimation System
4 Object
5 Linear Feature
51 Straight Feature
52 Curvilinear Feature
6 Line Sensor Camera
110 First Processing Device
120 Second Processing Device
A1 Arrangement Direction
D11 First Image Data
D12 Second Image Data
L12 Second Line (Virtual Line)
M1 Learned Model
P1 Reference Point
R1 Pixel Region

1. A data creation system configured to create, based on first image data, second image data for use as learning data to generate a learned model about an object, the data creation system comprising:
a deformer configured to generate, based on the first image data including a pixel region representing the object, the second image data by deforming a shape of the object,
the deformer being configured to generate the second image data to maintain a predetermined feature of the first image data before and after the shape of the object is deformed.

2. The data creation system of claim 1, further comprising an acquirer configured to acquire information about the predetermined feature, wherein
the deformer is configured to generate the second image data in accordance with the information acquired by the acquirer.

3. The data creation system of claim 1, wherein
the predetermined feature includes at least one linear feature included in the first image data, and
the deformer is configured to generate the second image data by deforming the shape of the object along one or more virtual lines aligned with the linear feature.

4. The data creation system of claim 1, wherein
the predetermined feature includes at least one linear feature included in the first image data, and
the deformer is configured to generate the second image data by deforming the shape of the object in an arrangement direction in which two or more virtual lines are arranged along the linear feature.

5. The data creation system of claim 3, wherein
the linear feature includes a straight feature.

6. The data creation system of claim 5, wherein
the straight feature concerns a boundary between a plurality of scan lines on the first image data depending on a line sensor camera that has shot the object.

7. The data creation system of claim 3, wherein
the linear feature includes a curvilinear feature.

8. The data creation system of claim 7, wherein
the curvilinear feature includes a circular feature or an elliptical feature.

9. The data creation system of claim 3, wherein
the deformer is configured to deform the shape of the object by setting a plurality of reference points on the virtual line and moving at least one reference point out of the plurality of reference points.

10. The data creation system of claim 9, wherein
the deformer is configured to move the at least one reference point while maintaining an order of arrangement of the plurality of reference points set on the virtual line.

11. The data creation system of claim 1, further comprising an acquirer configured to acquire information specifying a contour shape of the object that has been deformed, wherein
the deformer is configured to generate the second image data by deforming the shape of the object into the contour shape.

12. A learning system configured to generate the learned model using a learning data set, the learning data set including the learning data as the second image data, the second image data being created by the data creation system of claim 1.

13. An estimation system configured to estimate a particular condition of the object as an object to be recognized using the learned model generated by the learning system of claim 12.

14. A data creation method for creating, based on first image data, second image data for use as learning data to generate a learned model about an object, the data creation method comprising:
a deforming step including generating, based on the first image data including a pixel region representing the object, the second image data by deforming a shape of the object,
the deforming step including generating the second image data to maintain a predetermined feature of the first image data before and after the shape of the object is deformed.

15. A non-transitory storage medium storing a program designed to cause one or more processors to perform the data creation method of claim 14.

16. The data creation system of claim 2, comprising a first processing device and a second processing device, wherein
the first processing device includes the acquirer,
the second processing device includes the deformer, and
the first processing device is configured to transmit information about the predetermined feature to the second processing device.

17. A processing device functioning as the first processing device of the data creation system of claim 16.

18. A processing device functioning as the second processing device of the data creation system of claim 16.

19. A learning system configured to generate, using a learning data set including first image data as learning data, a learned model about an object, the first image data including a pixel region representing the object,
the learning system being configured to output, in response to the second image data, an estimation result similar to a situation where the first image data is subjected to estimation made about a particular condition of the object, the second image data being generated based on the first image data by deforming the shape of the object to maintain a predetermined feature of the first image data.

20. An estimation system configured to estimate a particular condition of an object as an object to be recognized,
the estimation system being configured to output, in response to the second image data, an estimation result similar to a situation where the first image data is subjected to estimation made about the particular condition of the object, the second image data being generated based on the first image data, including a pixel region representing the object, by deforming the shape of the object to maintain a predetermined feature of the first image data.
